(19) United States
(12) Patent Application Publication
(10) Pub. No.: US 2026/0003563 A1
(43) Pub. Date: Jan. 1, 2026

(54) AUDIO PRIORITIZATION

(71) Applicant: Zoox, Inc., Foster City, CA (US)

(72) Inventors: Parth Omprakash CHANDAK, Redwood City, CA (US); Lowell Ray PICKETT, Oakland, CA (US); Alexandre PILIPENKO, Belmont, CA (US); Steven Matthew SCHLEIBAUM, San Francisco, CA (US); Matthew Evan SILVERMAN, San Francisco, CA (US); Alex Nicholas WOLOWIECKI, San Francisco, CA (US); Jeremy Yi-Xiong YANG, New York, NY (US)

(21) Appl. No.: 18/758,573

(22) Filed: Jun. 28, 2024

(51) Int. Cl. G06F 3/16; H04S 7/00

(52) U.S. Cl. CPC G06F 3/165; H04S 7/303; H04S 2400/13

(57) ABSTRACT

Techniques are described herein for determining a state of a vehicle and obtaining first and second audio data for playback by the vehicle. Respective audio priorities are determined for the first and second audio data, wherein at least the audio priority associated with the first audio data is determined based on vehicle data. Based on the audio priorities, a relative volume of the first audio data the second audio data is determined and the vehicle is caused to play the first audio data at the relative volume to the second audio data.

### BACKGROUND

A vehicle may be configured to playback audio for one or more users of the vehicle. Various types of audio content are commonly played to enhance the driving experience, provide entertainment, and ensure important information is conveyed. The audio content provided for the users of the vehicle generally have the purpose of ensuring that all users have a pleasant, safe and informed traveling experience.

### BRIEF DESCRIPTION OF DRAWINGS

The detailed description is described with reference to the accompanying figures. The use of the same reference numbers in different figures indicates similar or identical components or features.

FIG. 1 is a pictorial diagram illustrating an example implementation for determining a vehicle state and controlling playback of audio data based on the vehicle state, in accordance with examples of the disclosure.

FIG. 2 is a top view of an autonomous vehicle in accordance with examples of the disclosure.

FIG. 3 is a top view of an autonomous vehicle, in accordance with examples of the disclosure.

FIG. 4 is a schematic diagram illustrating an example implementation for determining a vehicle state and controlling playback of audio data based on the vehicle state, in accordance with examples of the disclosure.

FIG. 5 is an example process of controlling playback of audio based on a state of a vehicle.

FIG. 6 is an example process of controlling playback of audio based on a state of a vehicle.

FIG. 7 depicts a block diagram of an example system for implementing the techniques described herein.

### DETAILED DESCRIPTION

This disclosure presents methods and systems for determining a state of a vehicle and controlling audio playback based on that state, for example in autonomous vehicles (AVs) configured to playback sound. The vehicle may be equipped with multiple speakers. These speakers may play various audio types, such as alerts, notifications, music, voice calls, navigation instructions, and traffic information, originating from sources like radio, streaming services, navigation systems, and vehicle systems. Features of this disclosure include prioritizing different audio data types based on their importance. For example, a seatbelt alert has higher priority than music playback. When a high-priority alert occurs, the system may mute or reduce the volume of lower-priority audio to ensure the alert is audible. The degree of volume adjustment may depend on the priority difference between the audio types, for example, the greater the priority difference, the more significant the volume adjustment. The priority of audio data can change based on vehicle data, such as with the state of the vehicle. An alert about an ajar door, for instance, is less critical when the vehicle is parked but becomes more important when the vehicle is moving. Similarly, a seatbelt alert has low priority when the vehicle is parked but increases in priority when the vehicle prepares for takeoff. If the alert remains unnoticed, its volume may be increased further, while the volume of ongoing audio (e.g., a phone call) may be reduced or silenced to move the attention of the passenger towards the prioritized audio. The system can also analyze speaker calls to determine their priority based on content and origin. For instance, a call with AV support has higher priority than an alert about an approaching destination. Voice analysis may detect urgency in a call, adjusting its priority accordingly. Calls where the passenger is on hold may be considered lower priority than active discussions. The adaptive audio management techniques described herein facilitates that critical information may be communicated effectively without overwhelming the vehicle occupants. Advantages of this system include improved safety and user experience by ensuring important alerts are heard, adapting to changing vehicle states, and intelligently managing audio priorities based on context and content.

This disclosure is directed to techniques, procedures, as well as methods, systems and computer-readable media, for determining a state of a vehicle and controlling playback of audio based on the state of the vehicle. The content of the speaker call, or audio data, may be analyzed to determine the priority of the audio. To exemplify, if the audio data is a voice call, voice analysis may determine that a sense of urgency is present, and the priority of the data may be increased due to this. The information of the audio data, e.g. by voice recognition, may be used to increase or decrease the priority of a speaker call. For instance, pause music or other indicators of the passenger being on a call where they are placed in que may be lower priority than calls where actual discussions are ongoing.

In examples, first vehicle data is determined. First and second of audio data is obtained and a first audio priority associated with the first audio data is determined based on the first vehicle data. A second audio priority associated with the second audio data is determined and a relative volume of the first audio data to the second audio is determined based on the audio priorities. The vehicle is caused to play the first audio data at the relative volume to the second audio data.

In examples, a state of a vehicle is determined, the vehicle may comprise one or more audio speakers. First and second of audio data is obtained, the first and second audio data may be for playback by the one or more audio speakers. Respective priorities are determined for the first and second audio data based on the state of vehicle. The one or more audio speakers may be controlled based on comparison between the respective priorities of the first and second audio data.

Vehicle data, as used herein, may be exemplified, but not limited to, a vehicle's speed, a fuel level, an engine temperature, GPS coordinates, a battery charge status, a tire pressure, an odometer reading, a maintenance schedule, a brake pad wear level, an oil life, emissions levels, a cabin temperature, an audio volume settings, a seat occupancy status, a door position, a window position, a headlight status, a current gear position, an airbag deployment status, a diagnostic trouble codes, real-time traffic information, navigation data, etc. The vehicle data may indicate a vehicle state.

Vehicles, whether conventional or autonomous, may exist or transition through various states during their operation. The state of a vehicle may relate to an operational status of the vehicle and/or a status of an environment of the vehicle, and may be exemplified by, but not limited to one or more of, driving, parked, idling, stopped, starting, ingress, egress, approaching destination, takeoff, turning off, reversing, accelerating, decelerating, cruising, proximity to other vehicles, proximity to pedestrians, proximity to emergency vehicles, etc.

In examples, the vehicle may change states which may cause control of the audio speakers to change. For example, it may be determined that the vehicle has changed states from a first state to a second state. The first audio priority is higher than the second audio priority in the first state, and the first audio priority is lower than the second audio priority in the second state. At the first state, based at least in part on the first audio priority being lower than the second audio priority, it is determined either to prevent playback of the first audio data or to attenuate a playback volume of the first audio data thereby providing attenuated first audio data. At the second state, based at least in part on the first audio priority being higher than the second audio propriety, it is determined either to prevent playback of the second audio data or to attenuate a playback volume of the second audio data thereby providing attenuated second audio data.

As explained above, the importance, e.g. the priority, of specific audio data may change depending on a state of the vehicle. An alert indicating that a door of the vehicle is ajar may be substantially ignored if the vehicle is at a parked state, but considerably more important if the vehicle is at a travelling state. Corresponding reasoning applies to e.g. alerts relating to unbuckled seatbelts, blind spot warnings, forward/reverse collision warning, navigational system alerts etc. This means that the priority of the audio data may change as the state of the vehicle changes, and consequently that a difference in playback volume between the sets of audio data change. The change may be either an increase or a decrease in difference in playback volume.

In examples, a first audio category associated with the first audio data and/or a second audio category associated with the second audio data may be determined. The respective audio priorities may be determined based at least in part on the associated audio category.

As used herein, audio categories, or types of audio data, may be exemplified by, but not limited to one or more of alerts, notifications, music, voice calls, navigational instructions, voice assistants, traffic information, ambient sound etc.

In examples, a first content of the first audio data and/or a second content of the second audio data may be determined. The respective audio priorities may be determined based at least in part on the associated content.

As used herein, content of audio data refers to what the audio portion of the audio data indicates. The content of audio data in a vehicle may broadly be categorized into categories exemplified, but not limited by music, voice conversations, navigation prompts, alerts, warnings, informational broadcasts, etc.

In examples, a first semantic content of the first audio data and/or a second semantic content of the second audio data may be determined. The respective audio priorities may be determined based at least in part on the associated content.

As used herein, semantic content of audio data describes information communicated in the audio data and/or a source/destination of the content. Determining semantical content of the audio data may for example include feature extraction, voice activity detection, speech recognition and using natural language processing (NLP) techniques, which allow the system to understand and interpret human language.

In examples, a playback location may be determined for the audio data. A playback direction of the audio data may be controlled by controlling the vehicle to playback the audio data in the playback direction. A playback direction of the audio data may be controlled by controlling at least one of the one or more audio speakers based at least in part the playback location. One or more gains may be determined for the audio speakers based on the playback location, and the audio speakers may be controlled based on the gains.

The playback direction may be controlled by e.g., selecting audio speakers closest to the playback location for playback of the audio data, and/or by controlling a phase of audio data to steer audio from a plurality of audio speakers.

As used herein, the playback location indicates a limited region of the vehicle. The limited region being a region inside the vehicle, a region in a vicinity outside the vehicle or combinations of regions inside and outside the vehicle.

As used herein, a playback direction indicates a direction of sound from a sound source, e.g., the one or more audio speakers, toward the playback location.

In examples, the playback location may be determined based at least in part on the audio data.

In examples, it may be determined that the audio data is intended for a specific user of the vehicle and, using at least on sensor of the vehicle, a first location of the specific user in relation to the vehicle may be determined. The playback direction of the audio data may be controlled by controlling at least one of the one or more audio speakers based, at least in part, on the first location.

By controlling at least one of the one or more audio speakers based in the first location, it is possible to direct the playback of the audio data towards the specific user.

In examples, it may be determined, using at least one sensor of the vehicle, that the location of the specific user has changed from the first location to a second location in relation to the vehicle. The second location may be different from the first location. The playback direction for the audio data may be controlled by controlling at least one of the one or more audio speakers based on the second location.

The at least one sensor may be exemplified by, but not limited to, pressure sensors configured to detect presence of passengers at specific seats, infrared (IR) sensors or cameras that are configured to detect heat signatures and movements, etc.

Detecting a change of location of the specific user, and controlling the speakers based on the detected change of location, allows playback of the audio data to track the specific user as they move about or change seats.

In examples, the first location is outside the vehicle and second location is inside the vehicle. In examples, the first location is inside the vehicle and the second location is outside the vehicle. In examples, both the first and second locations are inside or outside the vehicle.

In examples, the audio priority may be determined based at least in part on a user of the vehicle.

It may be that specific users have pre-determined individual preferences for how audio should be played or importance/priority thereof. Such preferences may be provided by a user profile and/or set in the vehicle.

In examples, an ambient sound level of the vehicle may be determined using at least one sensor of the vehicle. The playback volume of the audio data may be determined based on the ambient sound level.

The methods presented herein offer among other things, a versatile, safe and passenger friendly approach to controlling speakers of a vehicle based on a priority of audio data determined based on a state of the vehicle. State-based priority of audio streams for playback in a vehicle may provide a multitude of benefits that may enhance both the safety and comfort of a driving/riding experience. Intelligently managing and organizing different sets of audio data may enable the most critical/important information to be clearly and promptly delivered, while less urgent audio may be appropriately balanced or muted. By prioritizing audio data, the vehicle can maintain an optimal auditory environment that supports driver/rider focus and reduces potential distractions for different states of the vehicle. Specifically prioritizing audio data may improve safety for passengers of the vehicle. For example, when a crucial alert, such as a collision warning or a suddenly unbuckled seatbelt, is detected, the system may automatically lower the volume of entertainment audio or pause ongoing voice conversations. By prioritizing audio based on the state of the vehicle, a risk that passengers will get accustomed to, and start ignoring some alerts or warnings, is reduced. This facilitates that passengers may hear and respond to important information without significant delay. This may prevent accidents and enhance overall situational awareness. Alerts related to vehicle maintenance, such as low tire pressure or engine issues, may also be given priority, facilitating that the users are promptly informed of conditions that may affect vehicle performance and safety. Further to this, enhancing communication within a vehicle may be another benefit. Prioritizing audio data may allow for seamless integration of e.g. hands-free phone calls and voice commands. During a phone call, a playback volume of music or other background audio may be reduced or muted to ensure clear communication. Voice commands for navigation, climate control, or infotainment settings may be prioritized, allowing the users to interact with the vehicle's systems without unnecessary interference from other audio sources. Furthermore, prioritizing audio streams may contribute to a more enjoyable and personalized user experience. Overall, strategic prioritization of audio streams in a vehicle based on the state of the vehicle may deliver benefits by e.g., enhancing safety, improving communication, increasing vehicle comfort, etc.

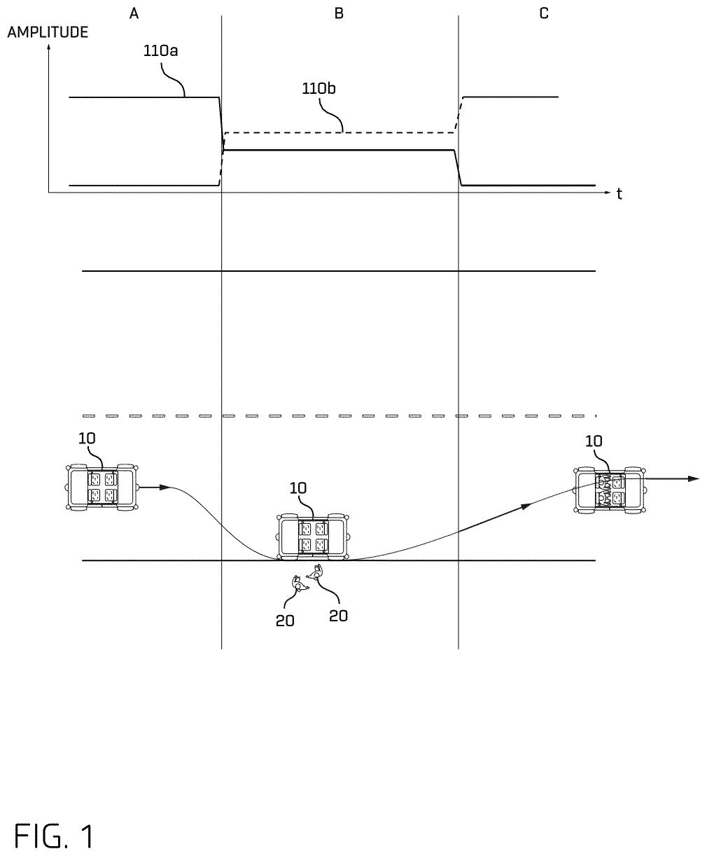

Examples are provided below with reference to FIGS. 1-7. Examples are discussed in the context of autonomous vehicles (AV); however, the methods, apparatuses, and components described herein are not limited to autonomous vehicles. In one example, the techniques described herein may be utilized in driver-controlled vehicles.

FIG. 1 is a schematic diagram illustrating an example implementation of the techniques described herein, in embodiments and examples of the disclosure.

In FIG. 1, an upper graph illustrates playback amplitude versus time for first audio data 110a and second audio data 110b. As used herein, playback amplitude is to means playback volume and the two terms may be used interchangeably. The lower graph shows a vehicle 10 at three different states A, B, C. The vehicle 10 is provided with at least one speaker for playback of the audio data 110a, 110b. At a first state A the vehicle 10 is empty and seen approaching a pickup location. At a second state B, the vehicle 10 is at the pickup location and passengers 20 are entering the vehicle 10. At a third state C, the passengers 20 are inside the vehicle 10, and the vehicle 10 travels from the pickup location towards a destination. As indicated by vertical lines extending across both the upper and the lower graph in FIG. 1, transitions between the states A, B, C align between the graphs although the upper graph is on a time scale and the lower graph is on more of a distance scale. The at least one audio speaker of the vehicle 10 is controlled to playback the first audio data 110a and the second audio data 110b at the respective playback amplitudes indicated in the upper graph.

At the first state, the first audio data 110a is associated with a higher playback volume than the second audio data 110b. The playback volume of the second audio data 110b is substantially zero when the vehicle 10 is at the first state. At the transitioning to the second state B, the playback volume of the second audio data 110b is increased and the playback volume of the first audio data 110a is decreased causing the playback volume of the second audio data 110b to be slightly above the playback volume of the first audio data 110a. At the transition to the third state C, the first audio data 110a is substantially muted whilst a playback volume of the second audio data 110b is further increased.

In FIG. 1 the first audio data 110a may be ambient or calming sounds provided to create a welcoming atmosphere for the passengers 20. The second audio data 110b may be a fasten seatbelt alert. At the first state A, as the vehicle 10 nears the pickup location, the first audio data 110a has higher audio priority than the second audio data 110b. As will be explained, this may be provided by determining a respective audio priority for the audio data 110a, 110b and comparing the audio priorities. As there are no passengers 20 in the vehicle 10, the second audio data 110b, the fasten seatbelt alert, has no purpose, whilst the first audio data 110a, calming and welcoming sounds, is played to welcome the passengers 20. At the first vertical line in FIG. 1, the vehicle 10 changes states from the first state A to the second state B. At the second state B, as the passengers 20 enter the vehicle 10, the passengers 20 are welcomed by the first audio data 110a, but at the same time urged to fasten their seatbelts. Therefore, at the second state B, the first audio data 110a is decreased in playback volume and the fasten seatbelt alert of the second audio data 110b is increased in playback volume. In other words, at the second state B, the audio priority of the second audio data 110b is higher than the audio priority of the first audio data 110a. At the second vertical line in FIG. 1, the vehicle 10 changes states from the second state B to the third state C. At the third state C, in which the vehicle 10 starts to travel to the destination of the passengers 20, all passengers 20 should have their seatbelts buckled. Consequently, the audio priority of the second audio data 110b is higher at the third state C than at the second state B. The first audio data 110a may have decreased or maintained audio priority at the third state C. To this end, the playback volume of the second audio data 110b is further increased at the third state C and the playback volume of the first audio data 110a is further decreased at the third state C.

The example given above is for illustrative purposes and it may very well be that the vehicle 10 is prohibited from taking off from the second state B if not all passengers 20 have their seatbelts fastened. However, one may envision one passenger 20 unbuckling their seatbelt at the third state C.

The example presented in FIG. 1 utilizes the states A, B, C to control the relative volumes between the first and second audio data 110a, 110b. It should be noted that this is one example and should not be considered a mandatory implementation. It should be mentioned that any suitable vehicle data as described herein may be utilized to control the relative volumes between the first and second audio data 110a, 110b.

In FIG. 1, a total playback sound pressure provided at the vehicle 10 is substantially maintained throughout the states A, B, C. In some examples, the playback sound pressure may very well differ increase or decrease between different states A, B, C.

As indicated in FIG. 1, the control of the playback volume of the first audio data 110a and the control of the playback volume of the second audio data 110b, may be considered a control of a difference in playback volume between the first and second audio data 110a, 110b.

In specific example with reference to FIG. 1, assume a first situation where a passenger 20 (rider, user) of the vehicle 10 in form of an AV is unbuckled, the AV is parked, and the passenger 20 is on a speaker call. This may be part of state B in FIG. 1 just after the passengers 20 have entered the AV 10. In this first situation, a seatbelt alert will have a comparably low priority and the speaker call a comparably high priority. Since there is no need at all to sound a seatbelt alert when the AV 10 is parked, the seatbelt alert may be muted, and the only audio played by the speakers are the audio call. Assume a second situation, following the first situation, where the AV is preparing for takeoff. The second situation may also be part of state B (or a separate state) just before takeoff and entry into state C. At the second situation the seatbelt alert becomes important as the AV 10 is likely configured to prevent takeoff if not all passengers 20 are buckled in. This means that the priority of the seatbelt alert is increased, causing a playback volume of the seatbelt alert to increase. The speaker call may still be ongoing at unchanged volume, but the increase in volume of the seatbelt alert changes the difference in volume between the seatbelt alert and the speaker call. In at least some examples, such a change in volume may be accomplished by modifying amplitudes of signals sent to a plurality of speakers within the cabin of the vehicle such that volume of the required notification (e.g., the seatbelt notification) is amplified with respect to other sounds for only the passenger requiring the notification while other passengers may not experience any change in volume of their respective primary audio sources. Further techniques for directing sound towards specific locations are described in U.S. patent application Ser. No. 15/983,008 entitled “Three dimensional sound for passenger notification” filed on May 17, 2018, the entire contents of which is hereby incorporated by reference for all purposes. If the second situation is maintained for an extended period of time, this may indicate that the passenger 20 is unaware of the seatbelt alert and the priority of the seatbelt alert may be increased further. This means that the seatbelt alert may be further increased in volume in order for it to be heard over the speaker call. However, in order not to increase a total sound pressure of the AV 10 and risk an uncomfortable sound level inside the AV 10, the further increase in priority of the seatbelt alert may cause a volume of the speaker call to decrease in order to ensure that the seatbelt alert is audible over the speaker call.

It may very well be that there are situations where a speaker call or other audio data is more important than e.g. AV alerts indicating an approaching destination etc. To this end, speaker calls may be analyzed with regards to content and/or origin. A call with a support service for the AV, i.e. the origin of the audio data is identified as a support service, may have higher priority than an alert indicating that the AV will arrive at its destination in five minutes. Correspondingly, a call to a local restaurant, i.e. the origin of the audio data is identified as a restaurant, may have lower priority than the alert indicating that the AV will arrive at its destination in five minutes.

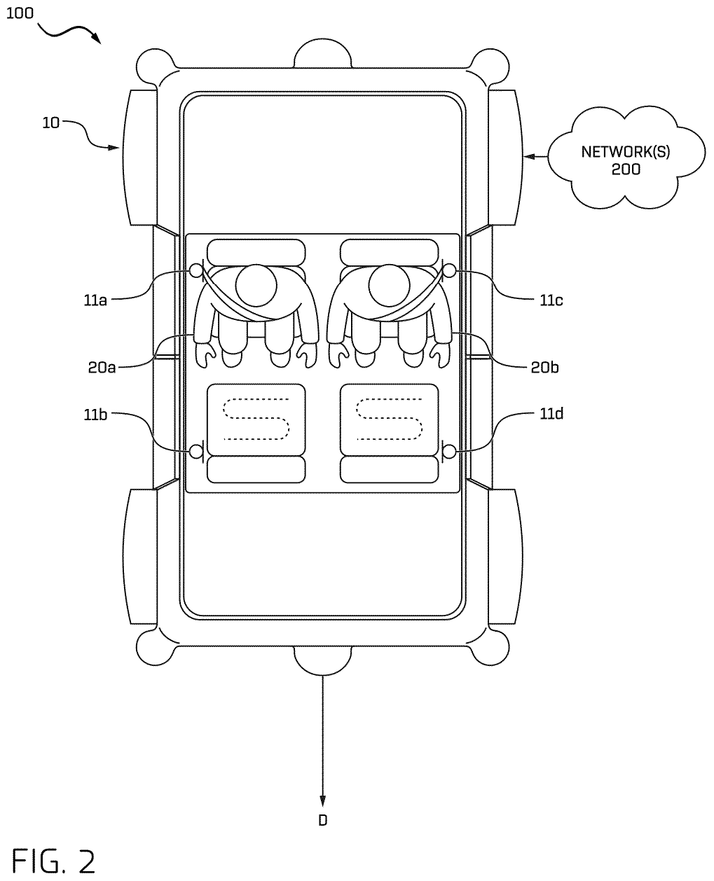

FIG. 2 is a top view of a vehicle 10 comprising a system 100 illustrating an example implementation of the techniques described herein, in embodiments and examples of the disclosure.

The vehicle 10 in FIG. 2 comprises a plurality of audio speakers 11a-d. Two passengers 20 are seated in the vehicle 10, both having their seatbelts fastened. The vehicle 10 is traveling in a direction D. The system 100 is configured to control the audio speakers 11a-d to playback audio data at different playback volumes depending on an audio priority of the respective audio data. The system 100 may be configured to control the audio speakers 11a-d according to any example or embodiment presented herein. Specifically, the system 100 is configured to determine the state of the vehicle 10 and obtain first audio data for playback by at least one audio speaker 11a-d of the plurality of audio speakers 11a-d. The system 100 is further configured to obtain second audio data for playback by at least one audio speaker 11a-d of the plurality of audio speakers 11a-d. The first and/or second audio data may be obtained through a network 200 operatively connecting the system 100 to remote processing circuitry, storage devices and/or computer systems. The system 100 may be configured to determine a first audio priority associated with the first audio data based on the state of the vehicle 10 and a second audio priority associated with the second audio data based on the state of the vehicle 10. The system 100 may further be configured to compare the first audio priority to the second audio priority and control the one or more audio speakers 11a-d based at least in part on the comparison.

In the example of FIG. 2, both passengers 20a, 20b have their seatbelts fastened. A first passenger 20a connects a speaker call to a friend using a Bluetooth connection between the first passenger's phone and the vehicle 10. The speaker call is in this example the first audio data. A second passenger 20b realizes that their destination must change (e.g., using NLP or otherwise to flag that incoming audio comprises such a request) and interacts with a navigation system of the vehicle by voice commands, the audio response from the navigation system is in this example the second audio data. As the vehicle 10 is at a traveling state, the system 100 may assign the navigational voice data a higher priority than the speaker call and control the audio speakers 11a-d accordingly. To this end, the audio speakers 11a-d may be controlled to decrease a playback volume of the first audio data, i.e. the speaker call, in favor of the second audio data, the navigational voice data.

In the above exemplified situation, the system 100 assigns the navigational voice data a higher priority than the speaker call. Traveling in the wrong direction will cause unnecessary energy consumption, waste time and impose unnecessary wear on components of the vehicle 10 and at least for this reason it may be more important to correct any destination issues than ensuring full speak intelligibility of the speaker call. However, if the speaker call was to a support center for the vehicle 10, identified e.g. by caller ID or by analysis of the semantic content of the audio, the priority of the speaker call may be higher than the priority of the navigational voice data causing a playback volume of the navigational voice data to be attenuated in favor of the speaker call. As indicated above, it may be that the priorities of the audio data change as the vehicle changes state. For instance, the navigational voice data may be given higher priority than the voice call at a first state indicating a first part of the navigation process where the route may be uncertain, or where a passenger is interacting with the navigation system. At a second state indicating a certain or wholly determined route, the navigational voice data may be given a lower priority than the speaker call.

As indicated in reference to FIG. 1 at the transition from the first state to the second state, the audio priority may very well be determined based on a presence of a user 20a, 20b in or at the vehicle 10. For example, by determining that users are present in or at the vehicle, service audio data such as audio data for calibrating microphones of the vehicle, may be assigned a lower priority if users are present. Correspondingly, a service call may be given lower priority than the audio data for calibrating microphones if no user is present in or at the vehicle 10.

In some of the examples presented, the playback volume of the speaker call is decreased at some states of the vehicle 10. The first passenger 20a may find the decreased playback volume of their speaker call a nuisance. To this end, in some examples, the system 100 may be configured to further control a playback direction of the first and second audio data. That is to say, in the example above, playback of the first audio data may be directed at the first passenger 20a and playback of the second audio data may be directed at the second passenger 20b.

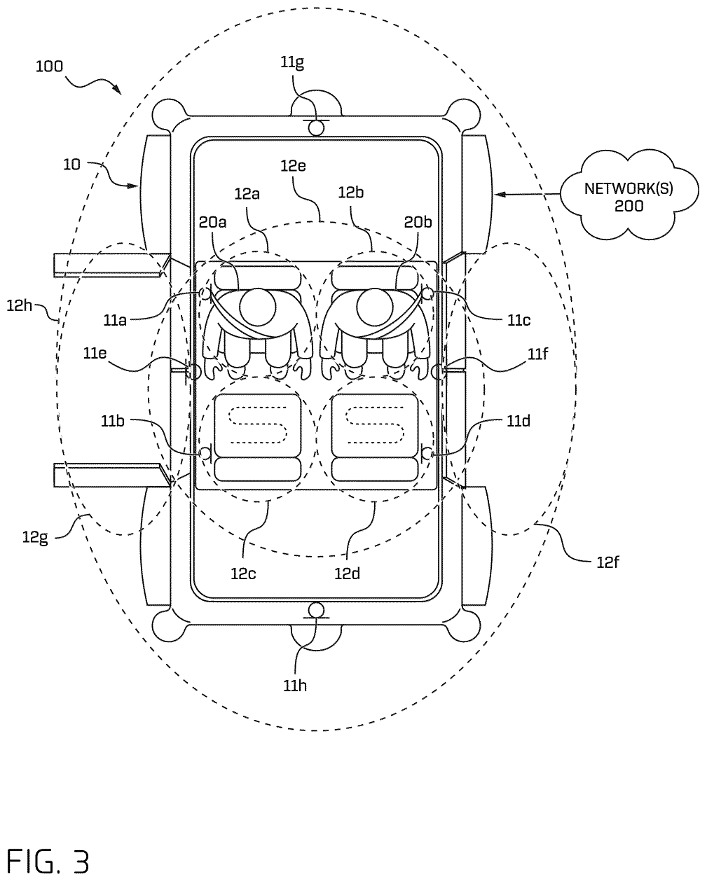

This is illustrated in FIG. 3. In FIG. 3, a top view of a vehicle 10 comprising a system 100 illustrating an example implementation of the techniques described herein, in embodiments and examples of the disclosure. The vehicle 10 shown in FIG. 3 may very well be the vehicle 10 shown in FIG. 2 and all features presented in reference to FIG. 2 may be provided by the vehicle 10 and/or system 100 of FIG. 3.

The vehicle 10 in FIG. 3 comprises a plurality of audio speakers 11a-h. A first plurality of audio speakers 11a-d are configured to direct sound to an interior of the vehicle 10. A second plurality of audio speakers 11e-h are configured to direct sound to an exterior of the vehicle 10. The plurality of audio speakers 11a-h may be controlled to direct sound towards one or more specific playback locations 12a-h. The sound may be directed by controlling a playback direction of the plurality of speakers 11a-h.

In FIG. 3, exemplary playback locations 12a-d for each passenger seat inside the vehicle 10 is shown. Audio data may be directed to one of these playback locations 12a-d in examples where the audio data is for a specific passenger 20a, 20b. Audio data for all passengers 20a, 20b inside the vehicle 10 may be directed to a general playback location 12e covering substantially the entire interior of the vehicle 10. Further to this, exemplary playback locations 12g-h are shown at each exterior side of the vehicle 10. Audio data may be directed to these playback locations 12g-h in examples where there the audio data is for passengers 20a, 20b entering or exiting the vehicle 10. Additionally, one exemplary playback location 12i is shown substantially surrounding the exterior of the vehicle 10. Audio data may be directed to this playback location 12i in examples where the audio data is for passengers or other people in the vicinity of the vehicle 10. The playback locations 12a-h shown in FIG. 3 are exemplary and the teachings of the present disclosure may be adapted to any number and/or arrangement of playback locations without loss of generality.

In FIG. 3, a first passenger 20a is seated at a first playback location 12a. Further to this, a first audio speaker 11a is located at the first playback location 12a. Specific audio data may be directed towards the first playback location 12a by determining gains for the plurality of speakers 11a-h. The audio speakers 11a-h may be controller based on their associated gain to steer the audio data towards a specific playback location 12a-h. Consequently, audio may be directed at the first passenger 20a at the first playback location 12a by controlling the first audio speaker 11a to playback the specific audio data at a higher playback volume than the other audio speakers 11b-h of the plurality of audio speaker 11a-h. It may be that the specific audio data is directed towards the first playback location 12a by controlling only the first audio speaker 11a to playback the specific audio data and preventing playback of the specific audio data by the other audio speakers 11b-h, i.e. muting playback of the specific audio data for the other audio speaker 11b-h.

As previously mentioned, the audio priority of audio data may be determined based on presence of a user 20a-b in or at the vehicle 10. In some examples, the audio priority may additionally, or alternatively, be determined based on a location of a user 20a-b. For instance, is a specific user 20a-b is at a side of the vehicle 10 where a collision is at risk of occurring, a warning alert may be issued with higher priority towards that specific user 20a-b compared to other users 20a-b of the vehicle 10.

In some examples, controlling a playback direction of the plurality of speakers 11a-h may comprise determining a time it would take for audio to travel from some or all of the plurality of audio speakers 11a-h to some or all playback locations 12a-h. By delaying, i.e. phase shifting the audio data specifically for some, or all, of the plurality of audio speakers 11a-h, a perceived playback volume at specific playback locations 12a-g may be increased or decreased. It may be that the perceived playback volume is decreased at one or more playback locations 12a-g and increased at one or more other playback locations 12a-b. In some examples, one or more audio speakers 11a-h comprise an array of individually controllable audio speakers enabling audio beamforming.

In some examples, the playback direction may be controlled to track a specific passenger 20 or groups of passengers. This may be provided by determining a location of the specific passenger 20 and control some, or all, of the plurality of audio speakers 11a-h to direct audio data towards the location of the specific passenger 20. By detecting that the passenger changes location, e.g. by one or more sensors of the vehicle 10, the direction of playback of the audio data may be changed accordingly. To exemplify, the vehicle 10 approaches a destination of one specific passenger 20 and audio data informing the specific passenger 20 of this is directed to a playback location 12a-h of the specific passenger 20. The audio data provides information and instructions on how to exit the vehicle 10 and in what direction the specific passenger 20 should walk in order to reach their final destination. As the vehicle 10 stops and the specific passengers 20 starts to exit the vehicle 10, the full audio data has not yet been played and some, or all, of the plurality of audio speakers 11a-h are controlled to playback audio data in playback directions towards a current playback location 12a-g of the specific passenger 20. As indicated in FIG. 3, some playback locations 12f-h may be exterior to the vehicle 10 allowing audio data to track a specific passenger 20 or groups of passengers from an outside of the vehicle 10 to an inside of the vehicle 10, or vice versa.

In some examples, the change of state of the vehicle 10 provided by the vehicle 10 approaching the destination of the specific passenger 20 may cause a change in priority of audio data. If the specific passenger 20 is listening to music, the playback volume of the music may be decreased in favor of the audio data providing information and instructions on how to exit the vehicle 10. This may be provided in combination with directing the audio data towards specific playback locations 12a-h.

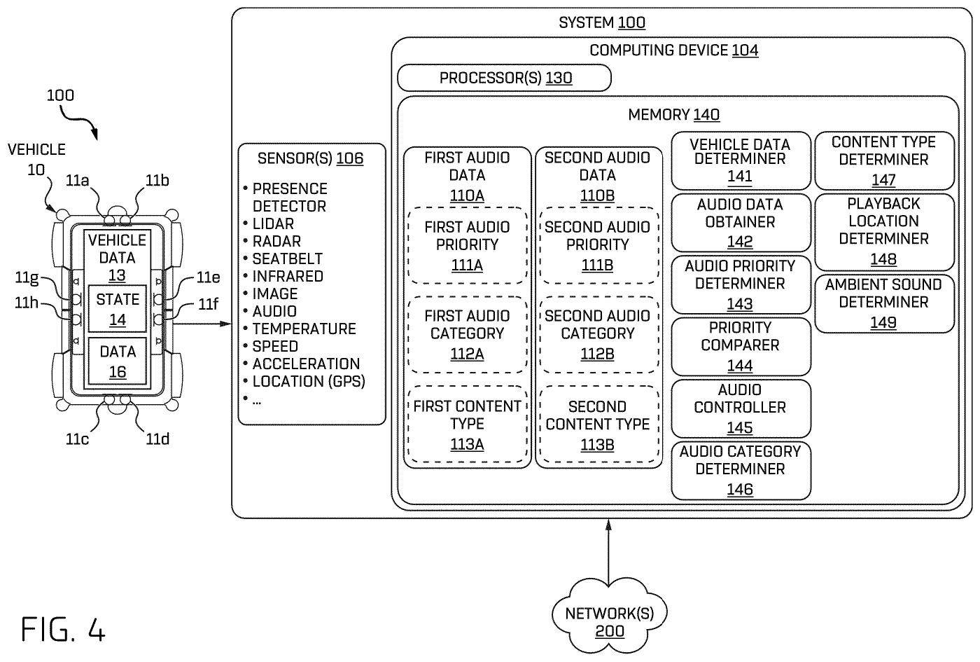

FIG. 4 depicts a block diagram of an example system 100 for implementing the techniques described herein. Although some not specifically mentioned on reference to the example system 100 of FIG. 4, the system 100 of FIG. 4 may be adapted to provide any feature, functionality or effect described herein.

The system 100 may be integrated in a vehicle 10, such as an AV as presented herein. However, the system 100 may in some examples be remote from the vehicle 10 and operatively connected to the vehicle 10. In some examples, the system 100 may be partly integrated in the vehicle 10 and partly remote from the vehicle 10, i.e. a distributed system 100.

The system 100 comprises or is operatively connected to a computing device 104. The computing device 104 may be any suitable computing device 104 and comprise one or more processors 130. A processor 130 as used herein may be any suitable processer, processing circuitry, controller or control circuitry. The computing device 104 further comprises or is operatively connected to one or more memories 140. The memory 140 may comprise instructions executable by the processor(s) 130. These instructions, when executed, may cause the processor(s) to perform specific operations, functions and features. In the following, these operations, features and functions will be described in reference to the general system 100.

The system 100 may be configured with one or more vehicle data determiners 141. The vehicle data determiner 141 is configured to determine vehicle data 13 of the vehicle 10 associated with the system 100. The vehicle data 13 may indicate a state 14 of the vehicle 10 associated with the system 100. The state 14 of a vehicle 10 may relate to an operational status of the vehicle 10 and may be exemplified by, but not limited to one or more of, driving (the vehicle 10 is in motion), parked (the vehicle 10 is stationary, with the engine/motor off or idling, generally in a designated parking space), idling (the engine is running or the motor is in standby, but the vehicle is not in motion), stopped (the vehicle 10 is temporarily halted, for example, at a traffic light, a stop sign, etc.), starting (the process of turning on the vehicle's engine or pre-charging an electric drive train), turning off (the process of shutting down the vehicle's engine or deactivating the electrical drive train), reversing (the vehicle is moving backward), accelerating (the vehicle 10 is increasing its speed), decelerating (the vehicle 10 is decreasing its speed), cruising (the vehicle 10 is moving at a substantially constant speed), in traffic (the vehicle 10 is moving slowly and/or making frequent short stops due to traffic congestion), towing (the vehicle 10 is pulling another vehicle or trailer), loading (the vehicle is being loaded with cargo or passengers), unloading (the vehicle 10 is being unloaded of cargo or passengers), refueling/charging (the vehicle is at a gas station or charging station replenishing its energy supply), maintenance/service (the vehicle 10 is undergoing maintenance or repair), emergency (the vehicle 10 is responding to an emergency, such as an ambulance or fire truck with sirens and lights active), accident (the vehicle 10 is having an accident), transport mode (the vehicle 10 is being transported on or by another vehicle, like a flatbed truck or towing vehicle), etc. Some states may be specific to AVs, such as, but not limited to, remote assistance mode (the vehicle is receiving remote guidance or control), fleet coordination (the vehicle 10 is communicating with other autonomous vehicles in a fleet for coordinated movement), data upload/download (the vehicle 10 is transmitting or receiving data, such as maps or software updates), sleep mode (the vehicle 10 is in a low-power state, conserving energy while not in use), diagnostic mode (the vehicle 10 is running self-diagnostics to check for system issues), learning mode (the vehicle 10 is actively learning from its environment, improving its algorithms through AI and machine learning), sensor calibration (the vehicle 10 is calibrating its sensors to ensure accurate readings), etc. The vehicle state 14 may further indicate data relating to the vehicle 10 such as a current number of passengers of the vehicle 10, a current location of passengers of the vehicle 10, a status of an energy source of the vehicle 10 etc.

The vehicle data determiner 141 may be configured to determine the state 14 of the vehicle 10 based at least in part on operational data 16 of the vehicle 10 The operational data may be provided by one or more sensors 106 of the vehicle 10 or the system 100. The one or more sensors 106 may be configured to measure, detect or otherwise obtain relevant operational data 16. The sensors 106 may be exemplified by, but not limited to one or more presence detectors configured to e.g., detect presence of persons in or at the vehicle 10, LIDAR sensors configured to e.g., detect location of passengers in the vehicle, radar sensors configured to e.g., detect location of passengers of the vehicle 10, seatbelt sensors configured to e.g., detect if a seatbelt is fastened or not, infrared (IR) sensors configured to e.g., detect heated bodies of the vehicle 10, image sensors configured to e.g., monitor an interior and/or exterior of the vehicle 10, audio sensors configured to e.g., detect sound levels and audio in and/or at the vehicle 10, temperature sensors configured to e.g., detect temperatures in and/or at the vehicle 10, speed sensors configured to e.g., detect a speed of the vehicle 10, acceleration sensors configured to e.g., detect an acceleration of the vehicle 10, location sensors (e.g., GPS, GLONASS etc.) configured to e.g., detect a location of the vehicle 10, etc. The data from the sensors 106 may be combined, otherwise processed, to provide operational data 16. For instance, a collision detection system in a vehicle 10 may use sensor data 10 from radar, lidar, cameras, ultrasonic sensors, and/or inertial measurement units (IMUs) to identify potential hazards. Radar and lidar sensor data 106 provide distance and object detection, cameras offer visual recognition, ultrasonic sensors handle close-range detection, and IMUs monitor vehicle dynamics. By integrating these sensor inputs, the collision detection system may issue timely warnings or initiate automatic braking to prevent collisions.

Understanding and determining these states 14 may be based on data, or combination of data, from different sensors 106, systems, and/or external sources (e.g., connected to the network 200) of the vehicle 10. To exemplify, when a vehicle 10 is driving, this state 14 may be determined using data 16 from e.g. a speedometer, GPS, and/or accelerometer. The speedometer provides real-time speed readings, the GPS confirms movement along a specific route, and the accelerometer detects changes in velocity. If the vehicle's speed exceeds a certain threshold, the vehicle 10 may be determined to be in the driving state. In examples, the speed determines the driving state such that driving state A relates to the AV driving less then 10 mph, driving state B relates to the AV driving between 10-20 mph, etc. A vehicle 10 may be considered parked when the speedometer reads zero for an extended period, and/or the transmission is at a “Park” position. The parked state may be corroborated by e.g. GPS data showing no change in location. Additionally, sensors on the doors and ignition may be utilized to confirm whether the vehicle 10 is turned off and securely parked. The idling state may be determined when the engine/motor of the vehicle is running/active, as indicated by engine/motor sensors and/or a tachometer, but the speedometer shows zero speed. Similarly, a vehicle 10 may be determined to be stopped when the vehicle is temporarily halted, such as at a traffic light or stop sign. The distinction from idling is usually a shorter duration, and the use of brake pedal sensors or brake force sensor, or a brake signal caused by a vehicle computing device and/or GPS data may be provided to detect temporary halts. The starting state may be identified by ignition/power system sensor(s) detecting a key turn or push-button start. This may be combined with data from an engine/motor control unit (ECU) indicating the engine has just begun running/been powered. Conversely, the turning off state may be detected by the ignition/power system signaling that the engine/motor has been turned off, e.g., no torque or voltage applied to the motor, and this may be corroborated by an RPM of the engine or a voltage of the motor dropping to zero or the vehicle computing device causing the power system to turn off. The reversing state may be detected by the transmission being in the reverse position, a rotational sensor of the wheels indicating a reverse direction and/or a current through the motor indicating a reverse direction. This data may be combined with data from the backup camera and sensors indicating backward movement. Accelerating and decelerating may be identified through the accelerometer and/or speedometer data, with positive changes in speed indicating acceleration and negative changes indicating deceleration. A throttle position sensor may be utilized to provide data on a position of an accelerator. The cruising state may be identified by the vehicle 10 maintaining a steady speed over a period, detected by e.g. the speedometer and/or GPS data indicating consistent movement. A vehicle 10 may be determined as being in traffic when there are frequent stops and starts, as indicated by speedometer fluctuations and/or by real-time traffic and/or location data from navigation systems. The transport mode may be determined based on a lack of engine/motor activity combined with GPS data showing movement. The remote assistance mode may be indicated by a vehicle communication system indicating data exchanges with remote operators. Fleet coordination may involve data exchange between vehicles in a fleet, monitored through the vehicle's communication systems to indicate coordinated movements and actions. A number and/or a location of passengers in or at the vehicle 10 may be determined by e.g., one or more image sensor, IR sensor, LIDAR, radar or combinations thereof.

The vehicle data determiner 141 may, in some examples, utilize sensors 106 and/or the network 200 to include information relating to an environment of the vehicle 10 in the state 14 of the vehicle. This means that the state 14 of the vehicle 10 may alternatively, or additionally, depend on an environment surrounding the vehicle 10. That is to say, the state 14 may well describe, indicate or otherwise teach of location/presence of pedestrians, location/presence of other vehicles, location/presence of emergency vehicles, location/presence of law enforcement, current and/or forecasted weather etc. It should be mentioned that the state 14 may, additionally or alternatively, indicate absence of pedestrians, other vehicles, emergency vehicles, law enforcement, etc. To exemplify, if an emergency vehicle or law enforcement officer is close to the vehicle 10, music or entertainment audio may be given a lower audio priority 111A, 111B to allow passengers of the vehicle to hear any instructions from the emergency vehicle or law enforcement officer. Further, if pedestrians are in the vicinity of the vehicle 10, these may be potential passengers and depending on the occupancy of the vehicle 10, audio data 110A, 110B advertising availability of the vehicle may be given higher priority.

The system 100 may further be configured with one or more audio data obtainers 142. The audio data obtainer 142 is configured to obtain audio data 110a, 110b, such as first audio data 110a and second audio data 110b for playback by one or more audio speakers 11a-f of the vehicle 10. The audio data 110a, 110b, for playback in or outside the vehicle 10 may be obtained from one or more audio sources that may cater to entertainment, communication, safety needs, etc. Generally, vehicles 10 are equipped with one or more entertainment audio sources. Traditional AM/FM radio offers access to local and national stations for music, news, talk shows, and sports. A vehicle 10 may be provided with one or more media players such as, but not limited to, CD, DVD or Blu-ray. Additionally, or alternatively, digital media and streaming using e.g. Bluetooth technology may be provided to facilitate wireless audio streaming from personal devices. Wi-Fi-, cellular or otherwise connected vehicles may provide streamed internet radio stations and services. GPS navigation systems in vehicles may provide spoken turn-by-turn directions and route guidance, often enhanced with real-time traffic updates. Voice assistants, integrated through systems like Apple CarPlay, Android Auto, and proprietary technologies such as Mercedes-Benz MBUX and BMW iDrive, enable voice commands and responses. Hands-free calling may be provided via Bluetooth, USB or any other communication interface, allowing phone calls to be made and received through the vehicle's audio system. The vehicle 10 itself may be configured to allow voice call from a communications module of the vehicle 10. The vehicle audio systems may further be configured to provide predetermined, prerecorded and/or configurable warnings, alerts and/or other notifications. Safety alerts may comprise audible warnings for issues such as seatbelt reminders, collision warnings, lane departure alerts, and blind spot detection. System notifications may be configured to provide a range of operational alerts, such as low fuel warnings, battery status updates, and/or notifications of doors or trunks being ajar. The vehicle 10 may be configured to playback sound from an ambient sound system, such as soothing sounds like nature sounds or white noise to create a relaxing environment. The infotainment system of the vehicle 10 may be configured to provide announcements and/or information services related to weather, news updates, vehicle-specific information, etc.

The system 100 may comprise one or more audio priority determiners 143. The audio priority determiner 143 may be configured to determine an audio priority 111a, 111b for the audio data 110a, 110b obtained by e.g., the audio data obtainer 142. In some examples, the audio priority determiner 143 may be configured to determine a first audio priority 111a associated with the first audio data 110a and a second audio priority 111b associated with the second audio data 110b. The audio priority determiner 143 may, as previously described, be configured to determine the audio priority 111a, 111b of the audio data 110a, 110b based at least in part on the state 14 of vehicle 10. As previously exemplified, determining an audio priority 110a, 110b for obtained audio data 110a, 110b is not a random process. Instead, the priority is determined based on one or more factors, one being the state 14 of the vehicle 10. Determining the audio priority 110a, 110b may be accomplished by a look-up table mapping specific states 14 of the vehicle 10 and specific audio data 110a, 110b to specific audio priorities 111a, 111b. The states 14 may be exemplified by any, some, or all states 14 previously mentioned. The audio data 110a, 110b may be mapped based on e.g. one or more of a type, category, source, content, etc. of the audio data 110a, 110b. It may be that the audio data 110a, 110b is obtained together with an associated audio priority 111a, 111b, in such examples, the audio priority determiner 143 may be configured to identify the associated audio priority 111a, 111b of respective audio data 110a, 110b. The audio priority determiner 143 may be configured with an artificial intelligence (AI) trained on historic priority data using machine learning (ML) to assist in determining audio priorities 111a, 111b for audio data 110a, 110b. Methods for ML may be exemplified by, but not limited to, linear regression, logistic regression, decision trees, random forest, support vector machines (SVMs), etc. The historic priority data may not be data indicating specific priorities for different audio data, but may be data indicating an action taken in situations where playback of two or more sets of audio data occur at the same time.

The system 100 may further be configured with a priority comparer 144. The priority comparer 144 is configured to compare audio priorities 111a, 111b for respective audio data 110a, 110b. In some examples, the priority comparer 144 may be configured to compare the first audio priority 111a associated with the first audio data 110a to the second audio priority 111b associated with the second audio data 110b. In other words, the audio priorities 111a, 111b of the obtained audio data 110a, 110b may be compared to each other to determine which audio data 110a, 110b that has the higher audio priority 111a, 111b, which audio data 110a, 110b that has the lower audio priority 111a, 111b and/or a difference in audio priority 111a, 111b between the sets of audio data 110a, 110b.

The system 100 may further comprise an audio controller 145. The audio controller 145 may be configured to control one or more audio speakers 11a-f of the vehicle 10 based on the comparison provided by the priority comparer 144. The one or more audio speakers of the vehicle 10 may be controlled based at least in part on the comparison. The controlling may be provided as previously indicated by muting lower priority audio data 110a, 1110b, by decreasing a playback volume of lower priority audio data 110a, 1110b, and/or by increasing a playback volume of higher priority audio data 110a, 1110b (or, otherwise causing the relative volumes received at a particular listener to be modified). In cases where two sets of audio data 110a, 1110b are to be played at different playback volumes, the sets of audio data 110a, 1110b may be provided to respective audio speakers 11a-f and a playback volume of each set of audio data 110a, 1110b may be independently controlled throughout the signal chain from obtaining the of the audio data 110a, 1110b to actually sounding the audio data 110a, 1110b from the respective speaker 11a-f. The respective sets of audio data 110a, 1110b may be combined in a digital domain before converted to analogue signals that are sounded by the audio speakers 11a-f. In this case, the gain of the respective set of audio data 110a, 1110b may be controlled before or during the combination of the data sets. Alternatively, both sets of audio data 110a, 1110b may be independently converted to analogue signals and combined in the analogue domain before playback by the audio speakers 11a-f. In this case, the gain of the respective set of audio data 110a, 1110b may be controlled at the digital domain and/or in the analogue domain before or during the combination of the data sets.

Regarding audio speakers, as mentioned, certain vehicles, such as AVs, may include one or more transducers such as audio speakers (speakers). The speakers may form part of an audio system of the vehicle and/or be controller separately by other systems of the vehicle. Speakers are generally configured to provide sound throughout a cabin, i.e. an interior, of the vehicle. The vehicle may be provided with speakers configured to provide sound in a vicinity of the vehicle, i.e. outside the vehicle. The speakers may be speakers of any suitable form or shape. The speakers may be located at any suitable location of the vehicle, but a general rule of thumb is that placement of lower frequency speakers is less sensitive than placement of higher frequency speakers due the human hearing being better adapted to determine directivity of mid-range and high frequency audio.

In one specific example, the state 14 of the vehicle 10 indicates drop-off of a passenger and heavy traffic in the environment around the vehicle 110. The audio data obtainer 142 obtains first audio data 110a from a customer service system of the vehicle 10. Audio data 110a from the customer service system may provide pre-recorded messages with instructions on how to e.g., exit the vehicle 10 or control an entertainment system of the vehicle 10. The audio data obtainer 142 obtains second audio data 110b from a navigation system of the vehicle 10 describing exit instructions for the passenger leaving the vehicle 10.

In one specific example, the state 14 of the vehicle 10 riding, i.e. on its way to a destination with passengers in the vehicle. The audio data obtainer 142 obtains first audio data 110a from an entertainment system of the vehicle 10. At the ride state, one passenger unbuckles their seatbelt and the audio obtainer 142 obtains second audio data 110b from a warning system of the vehicle. The audio priority determiner 143 assigns a higher priority to the second audio data 110b than the first audio data 110a. Based on a comparison provided by the priority compared 144, the audio controller 145 reduces a playback volume of the first audio data 110a to 10% by fading the playback volume for a predetermined first fading period. In one example, the predetermined first fading period is 500 ms. The passenger does not buckle their seatbelt in response to the fasten seatbelt alert and the vehicle 10 state 14 changes after a time period to a state indicating that at least one seatbelt has been unbuckled for more than a first unbuckled time period. In one example, the first unbuckled time period is 8 s. The audio priority determiner 143 increases the audio priority 111b of the second audio data 110b thereby increasing a difference in audio priority 111a, 111b between the first and second audio data 110a, 110b. Based on a comparison provided by the priority compared 144, the audio controller 145 mutes the first audio data 110a by fading the playback volume for a predetermined second fading period. In one example, the second fading period is 700 ms.

The vehicle 10 eventually arrives at a first destination and the state 14 of the vehicle 10 is changed to an egress state. At the egress state, the audio priority determiner 143 decreases the audio priorities 111a, 111b of the first and second audio data 110a, 110b to substantially zero. Based on a comparison provided by the priority compared 144, the audio controller 145 mutes the second audio data 110b. In some examples, the audio controller 145 mutes the second audio data 110b. In one example, at the egress state, the audio priority determiner 143 decreases only the audio priority 111b of the second audio data 110b to substantially zero (this may be the case when not all passengers will exit the vehicle 10 at the first destination). Based on a comparison provided by the priority compared 144, the audio controller 145 mutes the second audio data 110b by fading the playback volume for a predetermined third fading period and gradually increases the playback volume of the first audio data 110a to 100% during a first increasing period.

Optionally, in some examples, the audio system 100 may comprise an audio category determiner 146. The audio category determiner 146 may be configured to determine an audio category 112a, 112b of the audio data 110a, 110b. In some examples, the audio category determiner may be configured to determine a first audio category 112a for the first audio data 110a and/or a second audio category 112b for the second audio data 110b. Audio categories 112a, 112b may be exemplified by, but not limited to, voice calls, emergency alerts, warnings, music, podcasts, navigation prompts, system notifications, etc. The audio category determiner 146 may determine the audio category 112a, 112b for specific audio data 110a, 110b by e.g., determining a source of the audio data 110a, 110b. For example, if the source of the audio data 110a, 110b, is an entertainment system, the audio category 112a, 112b is likely to be music or podcasts. Correspondingly, if the source of the audio data 110a, 110b, is a navigation system, the audio category 112a, 112b is likely to be navigation prompts. The source may be traditional sources like AM/FM radio, digital sources such as audio data stored on physical devices like CDs, USB drives, or SD cards, or streamed from external devices via Bluetooth or Wi-Fi. Further, the source may be a navigation system, an onboard or remote diagnostic.

In examples wherein the system 100 comprises the audio category determiner 146, the audio priority determiner 143 may be configured to determine the audio priority 111a, 111b further based, at least in part on, the audio category 112a, 112b.

In one specific example, the audio category determiner 146 may determine that the first audio category 112a is a warning associated with an unfastened seatbelt. The audio category determiner 146 will determine the priority of the first audio data 110a based at least in part on the state 14 of the vehicle 10 and the first audio category 112. For instance, if the state 14 of the vehicle 10 is a parked state or an unoccupied state, the first audio priority 111a will be lower than if the vehicle 10 is traveling and occupied. If the speed of the vehicle 10 increases to above a threshold speed, the state 14 may be yet another state (e.g., a fast driving state) and the first audio priority 111a may be higher then the former state (where the vehicle 10 was driving with a lower speed).

In some examples, the audio system 100 may comprise a content type determiner 147.

The content type determiner 147 may be configured to determine a content type 113a, 113b of the audio data 110a, 110b. The content type determiner 147 may be configured to operate at the audio data 110a, 110b as obtained by the audio data obtainer 142, and it should be mentioned that the audio data obtainer 142 may be configured to obtain the audio data 110a, 110b from one or more microphones or other sound recording devices of the vehicle 10. Also, the content type determiner 147 may be configured to obtain the audio data 110a, 110b from one or more microphones or other sound recording devices of the vehicle 10 independently of the data obtainer 142. In some examples, the content type determiner 147 may be configured to determine a first content type 113a of the first audio data 110a and/or a second content type 113b of the second audio data 110b. The content type 113a, 113b indicates a type of content of the associated audio data 110a, 110b. The content type 113a 113b of audio data 110a, 110b may be determined through data, or combination of data, from various sources, user preferences, and/or real-time data processing. To exemplify, when audio data 110a, 110b is obtained, a source of the audio data 110a, 110b may be determined. Already from the source, some information regarding the content may be determined. For instance, if the source is an onboard diagnostic, the content of the audio data 110a, 110b is unlikely to be music. However, for instance voice calls may be utilized to provide diverse content, it may be emergencies, telephone conferences, friendly chatter etc. Correspondingly, remote assistance calls may be to schedule services, warn of upcoming traffic situations or emergency contact in case of accidents. In order to determine the content of e.g., audio data 110a, 110b in the form of voice data, the audio data 110a, 110b may require processing to determine its content. Such processing may involve algorithms and/or methods configured to detect and isolate spoken words from other sounds, a voice of a speaker may be identified and characteristics, such as tone, pitch, and cadence may be determined. NLP techniques may be applied to e.g. transcribe the audio data 110a, 110b into written text. NLP is a field of artificial intelligence that focuses on the interaction between computers and human languages. Determining the content may be a combination of determining the figurative and the literal content of the audio data 110a, 110b. The figurative content may be determined based at least in part of the characteristic of voice of the speaker, and the literal content may be determined based at least in part on the meaning of the words spoken.

In some examples, where the one of the audio data 110a, 110b is voice call data, the content type determiner 147 may be configured to determine the content type 113a, 113b of the audio data 110a, 110b based on e.g. analyzing a caller ID of incoming calls or number of an outbound call. Specific numbers, such as a number to a helpdesk or rider support of an AV may be assigned higher priority than calls to make dinner reservations. Correspondingly, calls to or from emergency services may be given escalated priorities. In some examples, a passenger may configure specific numbers from and to which calls should be given a higher priority. Such configurations may be provided through user preferences for each passenger.

In some examples, where the one of the audio data 110a, 110b comprise voice call, the content type determiner 147 may be configured to determine, e.g., by analyzing the voice call semantically, a content type 113a, 113b indicating a semantic content of the audio data, i.e. information communicated in the audio data 110a, 110b. The semantic content may indicate that the call is an emergency call and the audio priority determiner 143 may be configured to assign the audio data 110a, 110b a higher audio priority 111a, 111b based on the emergency content. The audio priority 111a, 111b based on the semantic content may differ depending on the state 14 of the vehicle 10. If, for example, the semantic content indicates a conversation regarding arrival times, the audio priority 111a, 111b may be determined to be higher if the state 14 indicate a delay in an estimated arrival time, or if the destination is near compared to if the vehicle 10 is on time and/or there is a fair amount of time left until the destination is reached.

Optionally, in examples, the system 100 may comprise a playback location determiner 148. The playback location determiner 148 may be configured to determine a playback location for the obtained audio data 110a, 110b. The playback locations may be exemplified by the playback locations 12a-h introduced in reference to FIG. 3. The playback location determiner 147 may be configured to analyze a nature and/or context of the audio data 110a, 110b e.g., based on the audio category 112a, 112b and/or the content type 113a, 113b. To exemplify, navigation prompts provide driving directions and are generally to be directed towards the driver. For an AV, navigation prompts may be directed towards a passenger currently interacting with the navigation system and/or having their arrival delayed due to e.g. traffic. The playback location determiner 147 may be configured to recognize such audio data 110a, 110b based on their association with e.g., GPS and/or navigation systems. Emergency alerts and warnings are generally designed to capture immediate attention and may be associated with safety-critical information. These alerts need to be heard clearly by passengers, so the system 100 may prioritize to play them through respective audio speakers 11a-f closest to each specific passengers or direct the playback towards each passenger in order to emphasize the importance of the audio data 110a, 110b. The urgency and nature of an alert, such as a collision warning or lane departure alert, may be analyzed by the playback location determiner 147 to decide the optimal playback location, often directing these sounds to the front speakers or to the specific side of the potential hazard. Correspondingly, as previously mentioned, a seatbelt alert may be intended for a specific seat of the vehicle 10 and the playback location determiner 147 may be configured to determine this based on e.g., determining what seatbelt sensors detect seatbelts and where passengers are seated. Voice calls are personal communication and may be directed to the passenger associated with the voice call to ensure clear conversation without disturbing other passengers. The playback location determiner 147 may be configured to recognize incoming calls or outgoing calls through e.g. Bluetooth connections between the passenger's device and the vehicle 10. Further to this, music and entertainment audio are generally intended for enjoyment by all occupants of the vehicle 10. The playback location determiner 147 may be configured to determine this type of audio data 110a, 110b by recognizing its audio category 112a, 112b and/or source, such as radio, streaming services, or media players, and typically distributes the sound evenly throughout the cabin. However, preferences of passengers may further refine this distribution. For instance, the playback location determiner 147 may utilize audio profiles to adjust audio settings based on who is in the vehicle 10, focusing entertainment audio to playback areas where passengers having selected audio profiles permitting entertainment audio are seated.

In examples where the system 100 comprise the playback location determiner 147, the audio priority determiner 143 may be configured to determine the audio priority 111A, 111B based, at least in part on the playback location. To this end, the audio priority determiner 143 may be configured to determine respective audio priorities 111A, 111B for at least two playback locations. In some examples, the audio priority determiner 143 may be configured to determine respective audio priorities 111A, 111B for at least two playback location in response to the playback location determiner 147 indicating localized playback.

In examples where the system 100 comprise the playback location determiner 147, the audio controller 145 may be configured to direct the audio data 110a, 110b towards the playback location determined by the playback location determiner 147. To this end audio controlled 145 may utilize any suitable technique for controlling the playback direction of the audio data 110a, 110b. In some examples, the audio controller may employ spatial audio processing to control the playback direction. Spatial audio processing provides a three-dimensional sound field within the vehicle 10. By manipulating timing, volume, and phase of audio data 110a, 110b sent to various audio speakers 11a-f, the system 100 may make it seem as if specific audio data 110a, 110b are coming from precise locations within the vehicle 10. This technology is particularly useful for enhancing safety alerts such as alerts indicating open doors or unfastened seatbelts by making them appear to come from the direction of the cause of the alert.

In some examples, the system 100 may comprise an ambient sound determiner 149. The ambient sound determiner 149 may be configured to determine an ambient sound inside and/or outside the vehicle 10. The ambient sound may be provided to the audio controller 145 such that the audio controller 145 may adjust a playback volume of the audio data 110a, 110b based at least in part on the ambient sound. This allows the playback volume to be increased in case the ambient sound is relatively high, ensuring that the audio data 110a, 110b is hearable above the ambient sound. Correspondingly, in case the ambient sound is relatively low, the playback volume of the audio data 110a, 110b may be decreased without adversely affecting the intelligibility of the audio data 110a, 110b.

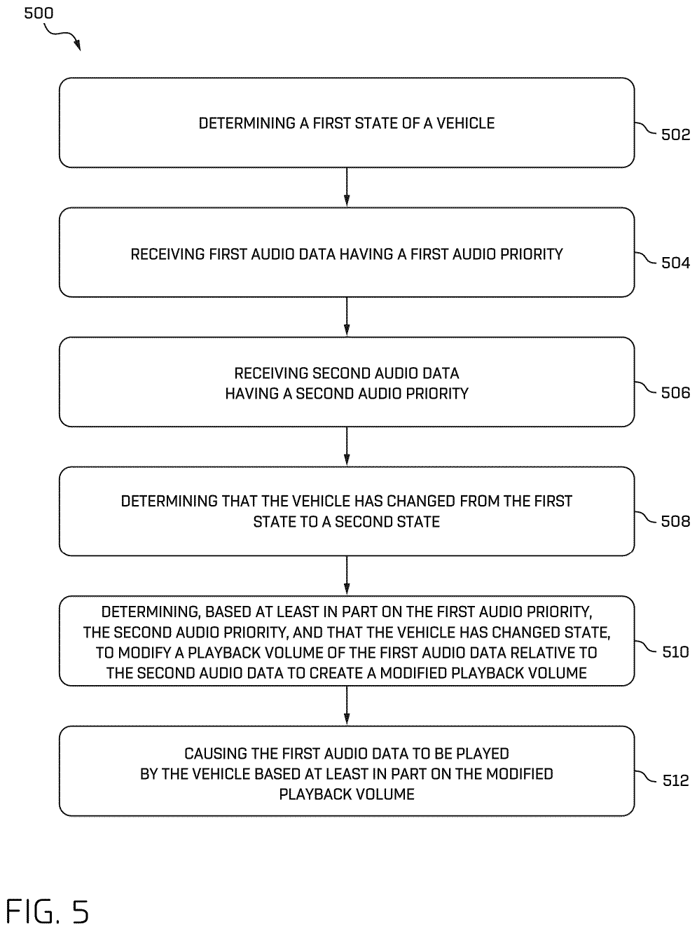

FIG. 5 depicts an example process 500 for controlling playback of audio data in a vehicle, in accordance with examples of the disclosure. The vehicle may be any suitable vehicle such as any vehicle presented herein. The process 500 comprises determining 502 a first state of a vehicle. The first state of the vehicle may be provided by any example presented herein such as e.g., the vehicle data determiner introduced with reference to FIG. 4.

The process 500 further comprises receiving 504 first audio data having a first audio priority. The first audio data associated with the first audio priority may be provided by any example presented herein such as e.g., the audio data obtainer 142 and/or the audio priority determiner introduced with reference to FIG. 4.

The process 500 further comprises receiving 506 second audio data having a second audio priority. The second audio data associated with the second audio priority may be provided by any example presented herein such as e.g., the audio data obtainer 142 and/or the audio priority determiner introduced with reference to FIG. 4.

The process 500 further comprises determining 508 that the vehicle has changed from the first state to a second state. The change in state may be provided by any example presented herein such as e.g., the vehicle data determiner introduced with reference to FIG. 4.

The process 500 further comprises determining 510, based at least in part on the first audio priority, the second audio priority and that the vehicle has changed state modify a playback volume of the first audio data relative to the second audio data to create a modified playback. Determining to modify the playback volume of the first audio data may be provided by any example presented herein such as e.g., the audio controller introduced with reference to FIG. 4.

The process 500 further comprises causing 512 the first audio data to be played by the vehicle based at least in part on the modified playback volume. Causing the playback of the first audio data based on the modified playback volume may be provided by any example presented herein such as e.g., the audio controller introduced with reference to FIG. 4.

The process 500 presented with reference to FIG. 5 may very well comprise any feature, example or effect presented herein. The process 500 may specifically comprise any details presented in reference to the system 100 of FIG. 4, and the system 100 of FIG. 4 may very well be configured to provide any, or all of the features of the process 500 of FIG. 5.

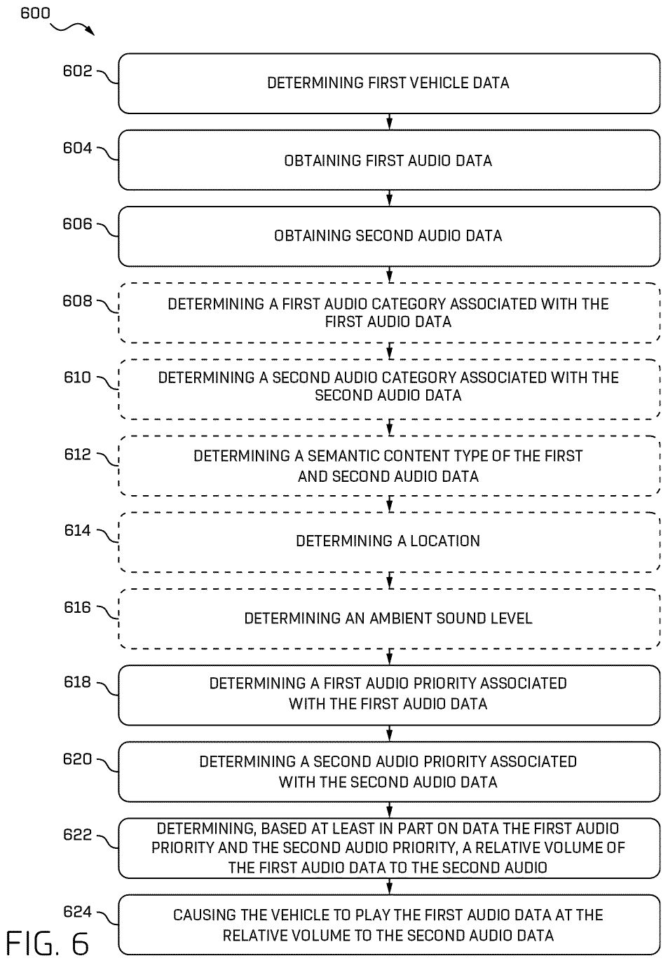

FIG. 6 depicts an example process 600 for controlling playback of audio data in a vehicle, in accordance with examples of the disclosure. The vehicle may be any suitable vehicle such as any vehicle presented herein. The process 600 comprises determining 602 first vehicle data of a vehicle. The vehicle data of the vehicle may be provided by any example presented herein such as e.g., the vehicle data determiner introduced with reference to FIG. 4. As mentioned, the vehicle data may comprise a state of the vehicle.

The process 600 further comprises obtaining 604 first audio data. The first audio data may provided by any example presented herein such as e.g., the audio data obtainer introduced with reference to FIG. 4.

The process 600 further comprises obtaining 606 second audio data. The second audio data may be provided by any example presented herein such as e.g., the audio data obtainer introduced with reference to FIG. 4.

The process 600 further comprises determining 618 a first audio priority associated with the first audio data. Determining the first audio priority associated with the first audio data may be provided by any example presented herein such as e.g., the priority determiner introduced in reference to FIG. 4.

The process 600 further comprises determining 620 a second audio priority associated with the second audio data. Determining the second audio priority associated with the second audio data may be provided by any example presented herein such as e.g., the priority determiner introduced in reference to FIG. 4.

The process 600 further comprises determining 622, based at least in part on data the first audio priority and the second audio priority, a relative volume of the first audio data to the second audio. Determining the relative volume may be provided by any example presented herein such as e.g., the priority comparer introduced in reference to FIG. 4.

The process 600 further comprises causing 624 the vehicle to play the first audio data at the relative volume to the second audio data. Causing the vehicle to play the first audio data may be provided by any example presented herein such as e.g., the audio controller introduced in reference to FIG. 4.

Optionally, in examples, the method 600 may comprise determining 608 an audio category associated with the first audio data. Determining an audio category associated with the first audio data may be provided by any example presented herein such as e.g., the audio category determiner introduced with reference to FIG. 4. In examples wherein an audio category associated with the first audio data is determined, determining 618 the first audio priority may further be based at least in part on the first audio category.

Optionally, in examples, the method 600 may comprise determining 610 an audio category associated with the second audio data. Determining an audio category associated with the second audio data may be provided by any example presented herein such as e.g., the audio category determiner introduced with reference to FIG. 4. In examples wherein an audio category associated with the second audio data is determined, determining 620 the second audio priority may further be based at least in part on the second audio category.

Optionally, in examples, the method may comprise determining 612 a content type of the first and/or second audio data. Determining a content type of the first and/or second audio data may be provided by any example presented herein such as e.g., the audio category determiner introduced in reference to FIG. 4. In examples wherein a content type of the first and/or second audio data is determined, determining 618, 620 the first and/or second audio priority may further be based at least in part on the content type of the first and/or second audio data.

Optionally, in examples, the method may comprise determining 614 a location of a user of the vehicle. Determining a location of a user may be provided by any example presented herein such as e.g., the playback location determiner introduced with reference to FIG. 4. In examples wherein a playback location for the first and/or second audio data is determined, causing 624 the vehicle to play the first audio data may further be based at least in part on the location of the user.

Optionally, in examples, the method may comprise determining 616 an ambient sound level of the vehicle. Determining an ambient sound level of the vehicle may be provided by any example presented herein such as e.g., the ambient sound determiner introduced with reference to FIG. 4. In examples wherein an ambient sound level is determined, controlling 624 the one or more audio speakers may further be based at least in part on the ambient sound level.

The process 600 presented with reference to FIG. 6 may very well comprise any feature, example or effect presented herein. The process 600 may specifically comprise any details presented in reference to the system 100 of FIG. 4 or the process 500 of FIG. 5, and the system of FIG. 4 and the process 500 of FIG. 5 may very well be configured to provide any or all of the features of the process 600 of FIG. 6.

It should be noted that although examples given herein are generally provided with two sets of audio data, the teachings of the present disclosure are in no way limited to two sets of audio data. The teachings herein are applicable to any number of sets of audio data.

### Additional Example Vehicle System

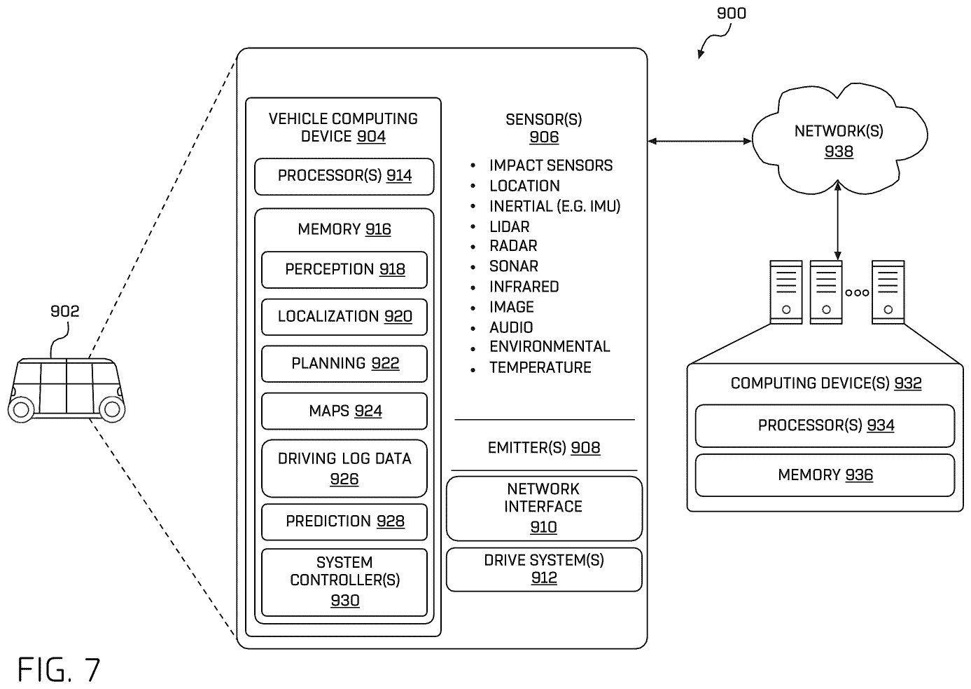

FIG. 7 illustrates a block diagram of an example system 900 that implements the techniques discussed herein. FIG. 7 may represent the example implementation of FIG. 4. In some instances, the example system 900 may include a vehicle 902, which may represent the vehicle 10 in FIGS. 1-4. In some instances, the vehicle 902 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 902 may be a fully or partially autonomous vehicle having any other level or classification. Moreover, in some instances, the techniques described herein may be usable by non-autonomous vehicles as well.

The vehicle 902 may include a vehicle computing device(s) 904 (representing computing device(s) 104 in FIG. 4), sensor(s) 906 (representing sensors 106 in FIG. 4), emitter(s) 908 (audio speakers 11 in FIGS. 1-4), network interface(s) 910, and/or drive system(s) 912. The system 900 may additionally or alternatively comprise computing device(s) 932.

In some instances, the sensor(s) 906 may include lidar sensors, radar sensors, ultrasonic transducers, sonar sensors, location sensors (e.g., global positioning system (GPS), compass, etc.), inertial sensors (e.g., inertial measurement units (IMUs), accelerometers, magnetometers, gyroscopes, etc.), image sensors (e.g., red-green-blue (RGB), infrared (IR), intensity, depth, time of flight cameras, etc.), audio sensors (microphones), wheel encoders, environment sensors (e.g., thermometer, hygrometer, light sensors, pressure sensors, etc.), etc. The sensor(s) 906 may include multiple instances of each of these or other types of sensors. For instance, the radar sensors may include individual radar sensors located at the corners, front, back, sides, and/or top of the vehicle 902. As another example, the cameras may include multiple cameras disposed at various locations about the exterior and/or interior of the vehicle 902. The sensor(s) 906 may provide input to the vehicle computing device(s) 904 and/or to computing device(s) 932. The sensor(s) 906 may be operable to detect a state of the vehicle 902.

The vehicle 902 may also include emitter(s) 908 for emitting light and/or sound, as described above. The emitter(s) 908 may include interior audio and visual emitter(s) to communicate with passengers of the vehicle 902. Interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 908 may also include exterior emitter(s). Exterior emitter(s) may include lights to signal a direction of travel or other indicator of vehicle action (e.g., indicator lights, signs, light arrays, etc.), and one or more audio emitter(s) (e.g., speakers, speaker arrays, horns, etc.) to audibly communicate with pedestrians or other nearby vehicles, one or more of which comprising acoustic beam steering technology.

The vehicle 902 may also include network interface(s) 910 that enable communication between the vehicle 902 and one or more other local or remote computing device(s). The network interface(s) 910 may facilitate communication with other local computing device(s) on the vehicle 902 and/or the drive component(s) 912. The network interface(s) 910 may additionally or alternatively allow the vehicle to communicate with other nearby computing device(s) (e.g., other nearby vehicles, traffic signals, etc.). The network interface(s) 910 may additionally or alternatively enable the vehicle 902 to communicate with computing device(s) 932 over a network 938. In some examples, computing device(s) 932 may comprise one or more nodes of a distributed computing system (e.g., a cloud computing architecture).

The vehicle 902 may include one or more drive components 912. In some instances, the vehicle 902 may have a single drive component 912. In some instances, the drive component(s) 912 may include one or more sensors to detect conditions of the drive component(s) 912 and/or the surroundings of the vehicle 902. By way of example and not limitation, the sensor(s) of the drive component(s) 912 may include one or more wheel encoders (e.g., rotary encoders) to sense rotation of the wheels of the drive components, inertial sensors (e.g., inertial measurement units, accelerometers, gyroscopes, magnetometers, etc.) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive component(s) 912. In some cases, the sensor(s) on the drive component(s) 912 may overlap or supplement corresponding systems of the vehicle 902 (e.g., sensor(s) 906).

The drive component(s) 912 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 912 may include a drive component controller which may receive and pre-process data from the sensor(s) and to control operation of the various vehicle systems. In some instances, the drive component controller may include one or more processors and memory communicatively coupled with the one or more processors. The memory may store one or more components to perform various functionalities of the drive component(s) 912. Furthermore, the drive component(s) 912 may also include one or more communication connection(s) that enable communication by the respective drive component with one or more other local or remote computing device(s).

The vehicle computing device(s) 904 may include processor(s) 914 (representing processor(s) 130 in FIG. 4) and memory 916 (representing memory 140 in FIG. 4) communicatively coupled with the one or more processors 914. Computing device(s) 932 may also include processor(s) 934, and/or memory 936. The processor(s) 914 and/or 934 may be any suitable processor capable of executing instructions to process data and perform operations as described herein. By way of example and not limitation, the processor(s) 914 and/or 934 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 916 (representing memory 140 in FIG. 4) and/or 936 may be examples of non-transitory computer-readable media. The memory 916 and/or 936 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), non-volatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 916 and/or memory 936 may store a perception component 918, localization component 920, planning component 922, map(s) 924, driving log data 926, prediction component 928, and/or system controller(s) 930—zero or more portions of any of which may be hardware, such as GPU(s), CPU(s), and/or other processing units.

The perception component 918 may detect object(s) in in an environment surrounding the vehicle 902 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, and/or acceleration associated with an object), and/or the like. Data determined by the perception component 918 is referred to as perception data. The perception component 918 may be configured to associate a bounding region (or other indication) with an identified object. The perception component 918 may be configured to associate a confidence score associated with a classification of the identified object with an identified object. In some examples, objects, when rendered via a display, can be colored based on their perceived class. The object classifications determined by the perception component 918 may distinguish between different object types such as, for example, a passenger vehicle, a pedestrian, a bicyclist, motorist, a delivery truck, a semi-truck, traffic signage, and/or the like. The perception component 918 may be operable to detect a state of the vehicle 902.

In at least one example, the localization component 920 may include hardware and/or software to receive data from the sensor(s) 906 to determine a position, velocity, and/or orientation of the vehicle 902 (e.g., one or more of an x-, y-, z-position, roll, pitch, or yaw). For example, the localization component 920 may include and/or request/receive map(s) 924 of an environment and can continuously determine a location, velocity, and/or orientation of the autonomous vehicle 902 within the map(s) 924. In some instances, the localization component 920 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some instances, the localization component 920 may provide data to various components of the vehicle 902 to determine an initial position of an autonomous vehicle for generating a trajectory and/or for generating map data, as discussed herein. In some examples, localization component 920 may provide, to the perception component 918, a location and/or orientation of the vehicle 902 relative to the environment and/or sensor data associated therewith. The localization component 920 may be operable to detect a state of the vehicle 902.

The planning component 922 may receive a location and/or orientation of the vehicle 902 from the localization component 920 and/or perception data from the perception component 918 and may determine instructions for controlling operation of the vehicle 902 based at least in part on any of this data. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic) that the system controller(s) 930 and/or drive component(s) 912 may parse/cause to be carried out, second instructions for the emitter(s) 908 may be formatted according to a second format associated therewith).

The driving log data 926 may comprise sensor data, perception data, and/or scenario labels collected/determined by the vehicle 902 (e.g., by the perception component 918), as well as any other message generated and or sent by the vehicle 902 during operation including, but not limited to, control messages, error messages, etc. In some examples, the vehicle 902 may transmit the driving log data 926 to the computing device(s) 932.

The prediction component 928 may generate one or more probability maps representing prediction probabilities of possible locations of one or more objects in an environment. For example, the prediction component 928 may generate one or more probability maps for vehicles, pedestrians, animals, and the like within a threshold distance from the vehicle 902. In some examples, the prediction component 928 may measure a track of an object and generate a discretized prediction probability map, a heat map, a probability distribution, a discretized probability distribution, and/or a trajectory for the object based on observed and predicted behavior. In some examples, the one or more probability maps may represent an intent of the one or more objects in the environment. In some examples, the planner component 922 may be communicatively coupled to the prediction component 928 to generate predicted trajectories of objects in an environment. For example, the prediction component 928 may generate one or more predicted trajectories for objects within a threshold distance from the vehicle 902. In some examples, the prediction component 928 may measure a trace of an object and generate a trajectory for the object based on observed and predicted behavior. Although prediction component 928 is shown on a vehicle 902 in this example, the prediction component 928 may also be provided elsewhere, such as in a remote computing device. In some examples, a prediction component may be provided at both a vehicle and a remote computing device. These components may be configured to operate according to the same or a similar algorithm.

The memory 916 and/or 936 may additionally or alternatively store a mapping system, a planning system, a ride management system, etc. Although perception component 918 and/or planning component 922 are illustrated as being stored in memory 916, perception component 918 and/or planning component 922 may include processor-executable instructions, machine-learned model(s) (e.g., a neural network), and/or hardware.

As described herein, the localization component 920, the perception component 918, the planning component 922, and/or other components of the system 900 may comprise one or more ML models. For example, the localization component 920, the perception component 918, and/or the planning component 922 may each comprise different ML model pipelines. In some examples, an ML model may comprise a neural network. An exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAD)), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, and the like. In some examples, the ML model discussed herein may comprise PointPillars, SECOND, top-down feature layers (e.g., see U.S. patent application Ser. No. 15/963,833, which is incorporated in its entirety herein), and/or VoxelNet. Architecture latency optimizations may include MobilenetV2, Shufflenet, Channelnet, Peleenet, and/or the like. The ML model may comprise a residual block such as Pixor, in some examples.

Memory 920 may additionally or alternatively store one or more system controller(s) 930 which may be configured to control steering, propulsion, braking, safety, emitters, communication, and other systems of the vehicle 902. These system controller(s) 930 may communicate with and/or control corresponding systems of the drive component(s) 912 and/or other components of the vehicle 902.

It should be noted that while FIG. 7 is illustrated as a distributed system, in alternative examples, components of the vehicle 902 may be associated with the computing device(s) 932 and/or components of the computing device(s) 932 may be associated with the vehicle 902. That is, the vehicle 902 may perform one or more of the functions associated with the computing device(s) 932, and vice versa.

### EXAMPLE CLAUSES

A: A system comprising: one or more processors; and one or more non-transitory computer-readable media storing instructions executable by the one or more processors, wherein the instructions, when executed, cause the system to perform operations comprising: determining a first state of a vehicle; receiving first audio data for playback by the vehicle, the first audio data having a first audio priority; receiving second audio data for playback by the vehicle, the second audio data having a second audio priority; determining that the vehicle has changed from the first state to a second state; determining, based at least in part on the first audio priority, the second audio priority, and that the vehicle has changed state, to modify a playback volume of the first audio data relative to the second audio data to create a modified playback volume; and causing the first audio data to be played by the vehicle based at least in part on the modified playback volume.

B: The system of clause A, wherein the first state is one or more states of a set of states comprising a driving state, a parked state, an idling state, a stopped state, a starting state, an ingress state, an egress state, an approaching destination state, a takeoff state, a seatbelt unfastened state, a reversing state, a proximal to other vehicles state, a proximal to pedestrians state, a proximal to emergency vehicles state, and the second state is one or more different states, or one more fewer states, of the set of states than the first state.

C: The system of clause A, wherein the instructions further cause the system to perform actions comprising: determining, based at least in part on the first audio data, a first audio category indicating a category of the first audio data; determining, based at least in part on the second audio data, a second audio category indicating a type of the second audio data; determining, based at least in part on the first audio category, the first audio priority; and determining, based at least in part on the second audio category, the second audio priority.

D: The system of clause A, wherein the instructions further cause the system to perform actions comprising: determining, based at least in part on the first audio data, a first semantic content indicating information communicated in the first audio data; determining, based at least in part on the second audio data, a second semantic content indicating information communicated f the second audio data; determining, based at least in part on the first content type, the first audio priority; and determining, based at least in part on the second content type, the second audio priority.

E: A method comprising: determining first vehicle data; obtaining first audio data; obtaining second audio data; determining, based at least in part on the first vehicle data, a first audio priority associated with the first audio data; determining a second audio priority associated with the second audio data; determining, based at least in part on data the first audio priority and the second audio priority, a relative volume of the first audio data to the second audio; and causing the vehicle to play the first audio data at the relative volume to the second audio data.

F: The method of clause E, further comprising: determining, based at least in part on the first audio data, a first audio category associated with the first audio data; determining, based at least in part on the second audio data, a second audio category associated with the second audio data; determining, based at least in part on the first audio category, the first audio priority; and determining, based at least in part on the second audio category, the second audio priority.

G: The method of clause E, further comprising: determining, based at least in part on the first audio data, a first semantic content indicating information communicated in the first audio data; determining, based at least in part on the second audio data, a second semantic content indicating information communicated in the second audio data; determining, based at least in part on the first semantic content, the first audio priority; and determining, based at least in part on the second semantic content, the second audio priority.

H: The method of clause E, wherein causing the vehicle to play the first audio data at the relative volume to the second audio data is based at least in part on: determining a location of a user of the vehicle; determining, for a plurality of speakers of the vehicle and based at least in part on the relative volume, a plurality of gains; and causing the plurality of speakers to emit the first and second audio data based at least in part on the plurality of gains.

I: The method of clause E, further comprising: determining that the first or second audio data is intended for a specific user of the vehicle; determining, using a sensor of the vehicle, a first location of the specific user in relation to the vehicle; and controlling, the vehicle to play the first or second audio data by controlling an audio speaker based at least in part on the first location.

J: The method of clause E, wherein the first vehicle data comprises a first state of the vehicle.

K: The method of clause J, wherein the first state is one or more states of a set of states comprising a driving state, a parked state, an idling state, a stopped state, a starting state, an ingress state, an egress state, an approaching destination state, a takeoff state, a reversing state, a proximal to other vehicles state, a proximal to pedestrians state, a proximal to emergency vehicles state.

L: The method of clause J, further comprising: determining that the vehicle has changed from the first state to a second state wherein the second state is different from the first state; and determining, based at least in part on the second state of the vehicle, the first audio priority, whereby the relative volume of the first audio data to the second audio is different at the second vehicle state than at the first vehicle state.

M: The method of clause E, further comprising: determining the first audio priority associated with the first audio data, based at least in part on one or more of: a presence of a user of the vehicle, or a location of the user in relation to the vehicle.

N: The method of clause E, further comprising: determining, using a sensor of the vehicle, an ambient sound level proximate the vehicle; and controlling, based at least in part on the ambient sound level, a playback volume for the first audio data or the second audio data.

O: The method of clause E, further comprising: determining, based at least in part on at least in part of the higher audio priority of the first and second audio priorities, to one or more of attenuate or mute a playback volume of the audio data associated with lower audio priority.

P: One or more non-transitory computer-readable media storing instructions executable by one or more processors, wherein the instructions, when executed, cause the one or more processors to perform operations comprising: determining, based at least in part on the first audio data, a first audio category associated with the first audio data; determining, based at least in part on the second audio data, a second audio category associated with the second audio data; determining, based at least in part on the first audio category, the first audio priority; and determining, based at least in part on the second audio category, the second audio priority.

Q: The one or more non-transitory computer-readable media of clause P, wherein the instructions, when executed, cause the one or more processors to further perform operations comprising: determining, based at least in part on the first audio data, a first audio category associated with the first audio data; determining, based at least in part on the second audio data, a second audio category associated with the second audio data; determining, based at least in part on the first audio category, the first audio priority; and determining, based at least in part on the second audio category, the second audio priority.

R: The one or more non-transitory computer-readable media of clause P wherein the instructions, when executed, cause the one or more processors to further perform operations comprising: determining a location of a user of the vehicle; determining, for a plurality of speakers of the vehicle and based at least in part on the relative volume, a plurality of gains; and causing the plurality of speakers to emit the first and second audio data based at least in part on the plurality of gains.

S: The one or more non-transitory computer-readable media of clause P, wherein the instructions, when executed, cause the one or more processors to further perform operations comprising: determining, based on the vehicle data, a first state of the vehicle.

T: The one or more non-transitory computer-readable media of clause S wherein the instructions, when executed, cause the one or more processors to further perform operations comprising: determining that the vehicle has changed from the first state to a second state wherein the second state is different from the first state; and determining, based at least in part on the second state of the vehicle, the first audio priority, whereby the relative volume of the first audio data to the second audio is different at the second vehicle state than at the first vehicle state.

### CONCLUSION

While one or more examples of the techniques described herein have been described, various alterations, additions, permutations, and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into subcomputations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow charts, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially a same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
one or more non-transitory computer-readable media storing instructions executable by the one or more processors, wherein the instructions, when executed, cause the system to perform operations comprising:
determining a first state of a vehicle;
receiving first audio data for playback by the vehicle, the first audio data having a first audio priority;
receiving second audio data for playback by the vehicle, the second audio data having a second audio priority;
determining that the vehicle has changed from the first state to a second state;
determining, based at least in part on the first audio priority, the second audio priority, and that the vehicle has changed state, to modify a playback volume of the first audio data relative to the second audio data to create a modified playback volume; and
causing the first audio data to be played by the vehicle based at least in part on the modified playback volume.

2. The system of claim 1, wherein the first state is one or more states of a set of states comprising a driving state, a parked state, an idling state, a stopped state, a starting state, an ingress state, an egress state, an approaching destination state, a takeoff state, a seatbelt unfastened state, a reversing state, a proximal to other vehicles state, a proximal to pedestrians state, a proximal to emergency vehicles state, and the second state is one or more different states, or one more fewer states, of the set of states than the first state.

3. The system of claim 1, wherein the instructions further cause the system to perform actions comprising:
determining, based at least in part on the first audio data, a first audio category indicating a category of the first audio data;
determining, based at least in part on the second audio data, a second audio category indicating a type of the second audio data;
determining, based at least in part on the first audio category, the first audio priority; and
determining, based at least in part on the second audio category, the second audio priority.

4. The system of claim 1, wherein the instructions further cause the system to perform actions comprising:
determining, based at least in part on the first audio data, a first semantic content indicating information communicated in the first audio data;
determining, based at least in part on the second audio data, a second semantic content indicating information communicated f the second audio data;
determining, based at least in part on the first content type, the first audio priority; and
determining, based at least in part on the second content type, the second audio priority.

5. A method comprising:
determining first vehicle data;
obtaining first audio data;
obtaining second audio data;
determining, based at least in part on the first vehicle data, a first audio priority associated with the first audio data;
determining a second audio priority associated with the second audio data;
determining, based at least in part on data the first audio priority and the second audio priority, a relative volume of the first audio data to the second audio; and
causing the vehicle to play the first audio data at the relative volume to the second audio data.

6. The method of claim 5, further comprising:
determining, based at least in part on the first audio data, a first audio category associated with the first audio data;
determining, based at least in part on the second audio data, a second audio category associated with the second audio data;
determining, based at least in part on the first audio category, the first audio priority; and
determining, based at least in part on the second audio category, the second audio priority.

7. The method of claim 5, further comprising:
determining, based at least in part on the first audio data, a first semantic content indicating information communicated in the first audio data;
determining, based at least in part on the second audio data, a second semantic content indicating information communicated in the second audio data;
determining, based at least in part on the first semantic content, the first audio priority; and
determining, based at least in part on the second semantic content, the second audio priority.

8. The method of claim 5, wherein causing the vehicle to play the first audio data at the relative volume to the second audio data is based at least in part on:
determining a location of a user of the vehicle;
determining, for a plurality of speakers of the vehicle and based at least in part on the relative volume, a plurality of gains; and
causing the plurality of speakers to emit the first and second audio data based at least in part on the plurality of gains.

9. The method of claim 5, further comprising:
determining that the first or second audio data is intended for a specific user of the vehicle;
determining, using a sensor of the vehicle, a first location of the specific user in relation to the vehicle; and
controlling, the vehicle to play the first or second audio data by controlling an audio speaker based at least in part on the first location.

10. The method of claim 5, wherein the first vehicle data comprises a first state of the vehicle.

11. The method of claim 10, wherein the first state is one or more states of a set of states comprising a driving state, a parked state, an idling state, a stopped state, a starting state, an ingress state, an egress state, an approaching destination state, a takeoff state, a reversing state, a proximal to other vehicles state, a proximal to pedestrians state, a proximal to emergency vehicles state.

12. The method of claim 10, further comprising:
determining that the vehicle has changed from the first state to a second state wherein the second state is different from the first state; and
determining, based at least in part on the second state of the vehicle, the first audio priority, whereby the relative volume of the first audio data to the second audio is different at the second vehicle state than at the first vehicle state.

13. The method of claim 5, further comprising:
determining the first audio priority associated with the first audio data, based at least in part on one or more of:
a presence of a user of the vehicle, or
a location of the user in relation to the vehicle.

14. The method of claim 5, further comprising:
determining, using a sensor of the vehicle, an ambient sound level proximate the vehicle; and
controlling, based at least in part on the ambient sound level, a playback volume for the first audio data or the second audio data.

15. The method of claim 5, further comprising:
determining, based at least in part on at least in part of the higher audio priority of the first and second audio priorities, to one or more of attenuate or mute a playback volume of the audio data associated with lower audio priority.

16. One or more non-transitory computer-readable media storing instructions executable by one or more processors, wherein the instructions, when executed, cause the one or more processors to perform operations comprising:
determining, based at least in part on the first audio data, a first audio category associated with the first audio data;
determining, based at least in part on the second audio data, a second audio category associated with the second audio data;
determining, based at least in part on the first audio category, the first audio priority; and
determining, based at least in part on the second audio category, the second audio priority.

17. The one or more non-transitory computer-readable media of claim 16, wherein the instructions, when executed, cause the one or more processors to further perform operations comprising:
determining, based at least in part on the first audio data, a first audio category associated with the first audio data;
determining, based at least in part on the second audio data, a second audio category associated with the second audio data;
determining, based at least in part on the first audio category, the first audio priority; and
determining, based at least in part on the second audio category, the second audio priority.

18. The one or more non-transitory computer-readable media of claim 16, wherein the instructions, when executed, cause the one or more processors to further perform operations comprising:
determining a location of a user of the vehicle;
determining, for a plurality of speakers of the vehicle and based at least in part on the relative volume, a plurality of gains; and
causing the plurality of speakers to emit the first and second audio data based at least in part on the plurality of gains.

19. The one or more non-transitory computer-readable media of claim 16, wherein the instructions, when executed, cause the one or more processors to further perform operations comprising:
determining, based on the vehicle data, a first state of the vehicle.

20. The one or more non-transitory computer-readable media of claim 19 wherein the instructions, when executed, cause the one or more processors to further perform operations comprising:
determining that the vehicle has changed from the first state to a second state wherein the second state is different from the first state; and
determining, based at least in part on the second state of the vehicle, the first audio priority, whereby the relative volume of the first audio data to the second audio is different at the second vehicle state than at the first vehicle state.
